(19) United States
(12) Patent Application Publication
(10) Pub. No.: US 2008/0011931 A1
(43) Pub. Date: Jan. 17, 2008

(54) Stand for supporting a cut tree trunk

(76) Inventors: Roben E. Ryberg, Boonsboro, MD (US); Jose Antonio Iriondo, Elbar (ES)

Correspondence Address: BIRCH STEWART KOLASCH & BIRCH, PO BOX 747, FALLS CHURCH, VA, 22040-0747, US

(21) Appl. No.: 11/826,157

(22) Filed: Jul. 12, 2007

Related U.S. Application Data
(60) Provisional application No. 60/830,613, filed on Jul. 14, 2006.

(51) Int. Cl. F16M 13/02

(52) U.S. Cl. 248/523

(57) ABSTRACT

A stand for supporting a cut tree trunk has two hinged locking arms which surround the trunk. The arms are connected by handles which lock the arms in position in the fashion of a locking pliers. Four legs each have an opening for receiving the arms and are placed at different angles to support the tree. The legs extend inside the arms and have pointed ends to contact the tree and hold it firmly in position. A watering pan is also provided for supporting the bottom of the tree and for receiving water. All the parts can be disassembled and placed within the watering pan for storage.

This Nonprovisional application claims priority under 35 U.S.C. §119(e) on U.S. Provisional Application No. 60/830,613 filed on Jul. 14, 2006, the entire contents of which are hereby incorporated by reference.

### BACKGROUND OF THE INVENTION

1. Field of the Invention

The present invention relates to a portable stand for supporting a cut tree, such as a Christmas tree in a vertical position, and more particularly to a portable stand for supporting a cut tree having an adjustable locking arrangement.

2. Discussion of the Background

The use of the stand for supporting a cut tree is well known in many cultures. In particular, cut trees are used during the Christmas celebration in many countries. In order to support the cut tree, traditional stands have often employed a watering pan connected through various brackets to a circular central bracket through which adjustable screws are tightened to hold the tree in position. This arrangement, while common, has many difficulties. First, it is difficult to place the tree vertically within the central circular bracket. It is also difficult to tighten these screws sufficiently to lock the tree in position. It is also difficult to hold the tree vertical while the screws are being tightened. The pans are particularly difficult to reach and, often result in spilled water. Many of these are not uneasily taken apart for storage. Since use of such a stand is typically seasonal, storage is a great concern.

U.S. Pat. No. 5,797,580 is a more recent attempt to solve these problems using a pair of hinged locking jaws which encircle the tree trunk. The locking arms are joined to a pair of handles of the locking pliers type so that when the arms are placed around the tree, they may be tightened in the contact with the tree trunk merely by clamping the two handles together in a well known fashion. This mechanism also allows for adjusting the size of the arms. While this arrangement was a great advance over prior art devices, the particular arrangement was not easily disassembled for storage since the four legs were permanently mounted on the arms.

### SUMMARY OF THE INVENTION

The present invention overcomes these difficulties and provides a tree stand which is easily disassembled for storage.

The present invention further provides a tree stand which is adjustable for different size tree trunks.

The present invention further provides a tree stand which is easy to operate and adjustable.

The present invention further provides a tree stand which has a watering pan which is easily reachable.

The present invention further provides for a tree stand which is easily disassembled and packaged for storage.

The present invention achieves these results by providing a pair of locking arms which are pivoted in conjunction with a locking pair of handles to adjustably clamp the arms around the trunk of the tree. Removable legs include an opening through which the arms pass so that the legs are used to help the tree trunk.

### BRIEF DESCRIPTION OF THE DRAWINGS

More complete appreciation of the invention and many of the attendant advantages thereof will be readily obtained as the same becomes better understood by reference of the following detailed description when considered in connection with the accompanying drawings wherein:

FIG. 1 is a perspective view of the present invention;

FIG. 2 is a side view of the present invention;

FIG. 3 is an end view of the present invention;

FIG. 4 is a top view of the present invention;

FIG. 5 is an end view of the present invention without the tree trunk;

FIG. 6 is a top view of the present invention without a tree trunk;

FIG. 7 is a side view of the present invention from a different angle;

FIG. 8 is a top view of the present invention with the handles in a different position;

FIGS. 9 and 11 are front and top views of a leg in the present invention;

FIG. 10 is a perspective view of a locking clip;

FIG. 12 is a top view of the locking arms;

FIGS. 13 and 14 are top views of the locking arms of the present invention used with two different size trunks.

### DESCRIPTION OF THE PREFERRED EMBODIMENTS

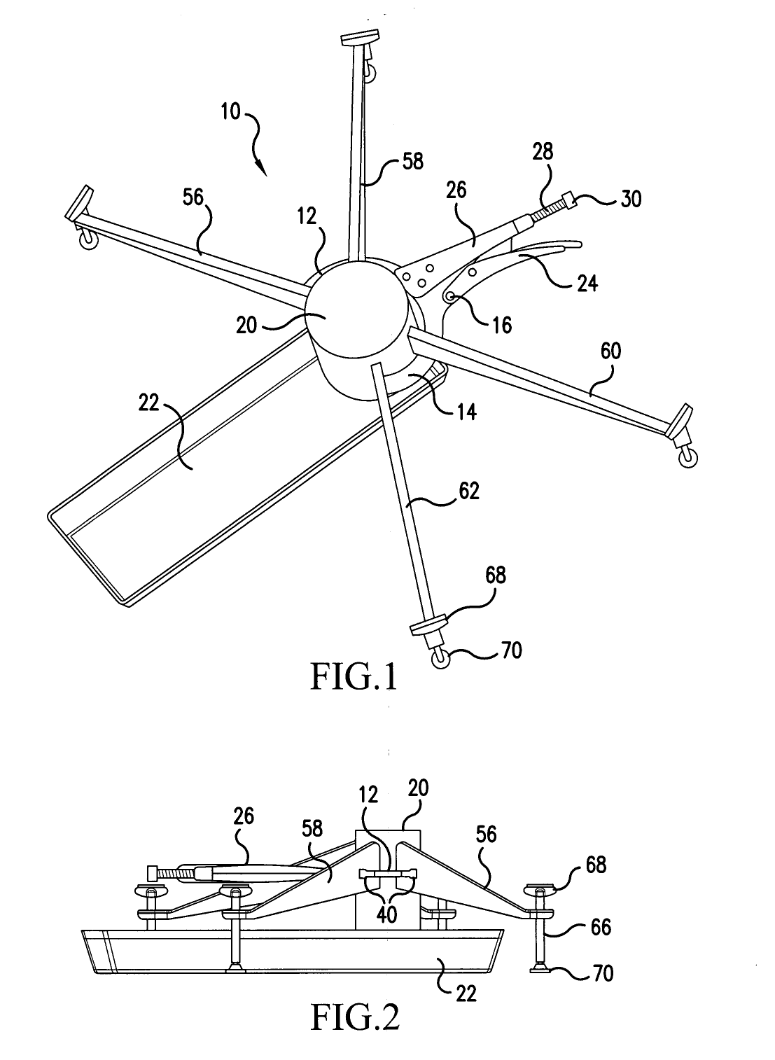

Referring now to the drawings, wherein reference numerals designate identical or corresponding parts throughout the respective views and more particularly to FIG. 1 thereof, wherein the tree stand 10 includes curved locking arms 12 and 14 pivoted at their joinder point 16. A fixed locking handle 26 is secured by welding or other means to locking arms 12 so locking arm 14 may pivot about point 16. A pivoted handle 24 is pivoted to the locking arm 14. A threaded and adjustable locking shaft 28 having a knurled adjusting knob 30 extends inwardly of the rigid handle 26 to adjust toggles (not shown) which lock the handles in position, as is well known. Legs 56, 58, 60 and 62 extend from the locking jaws radially outwardly to support and stabilize the trunk. The ends of each leg may include supporting feet, including a threaded shaft 66 to adjust the height of the legs, flooring engaging pads 70 and a wing nut 68 for turning the shaft. Various other arrangements can be used in place of the wing nut as long as they are easily turned by hand.

A pan 22 is placed between the legs of the stand at least below the bottom of the trunk 20 so as to support the bottom of the trunk and to receive water therein. Preferably, the trunk is set at one end of the pan so that the other end extends outwardly far enough that it is easy for the user to fill the pan with water.

The pan may be made of metal or plastic or any other material which is water tight. The length of the pan is preferably longer than the length of the legs so that when the stand is disassembled the legs will fit longitudenally within the pan along with the other parts of the stand so that the pan becomes a container for storing the stand.

FIG. 2 shows a side view of the stand, where the locking handles are moved to a position over the pan. The exact position of the handles is not critical and so that the handles can be placed in a position where they are least visible. Likewise, the pan may be placed in position which removes it from foot traffic so as to avoid accidental spillings.

FIG. 2 also shows that the legs include an opening 40 which receives the locking arms there through.

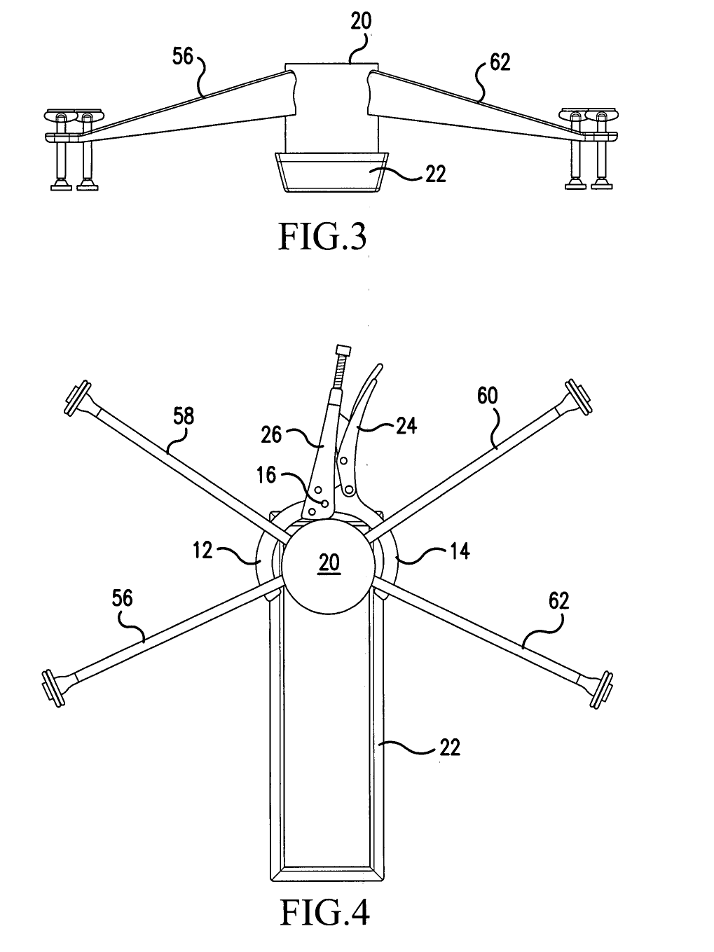

FIG. 3 shows a similar view from the end of the pan 22.

FIG. 4 shows a top view of the arrangement shown in FIG. 1. It should be noted that the ends of the legs extend inwardly from the locking arms 12 and 14, so that the ends of the legs actually contact the tree trunk. Thus, the locking arms do not actually clamp onto the tree trunk, but instead force the ends of the legs against the trunk to hold it in position.

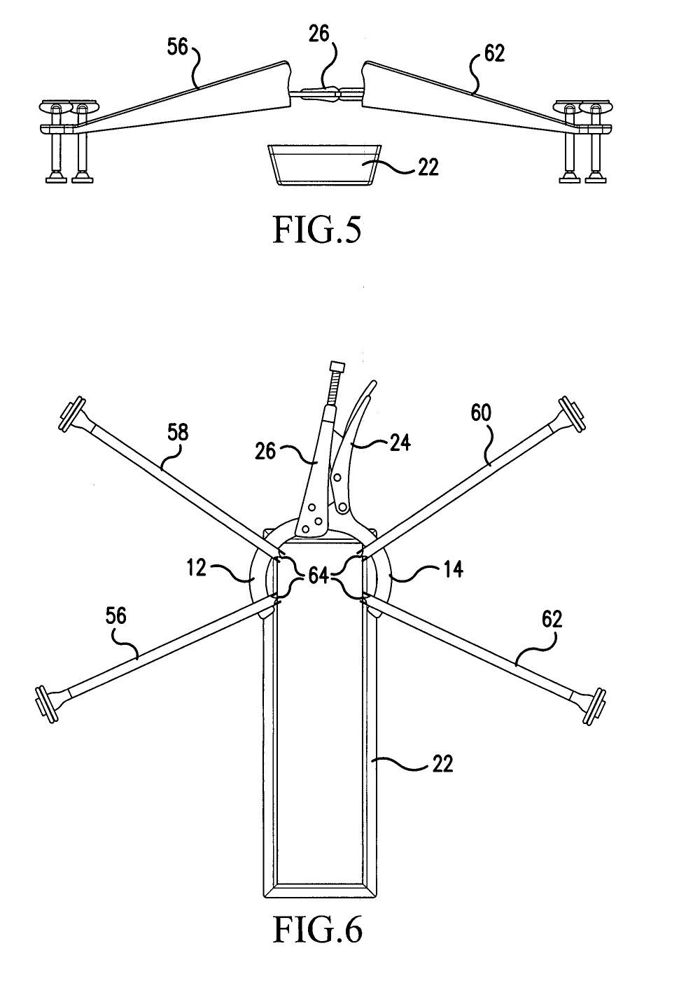

FIG. 5 shows a similar view to FIG. 3 but with the tree trunk removed.

FIG. 6 shows a similar view to FIG. 4 but with the tree trunk removed. As it is better seen in this figure, the ends 64 of the legs can assume a shape which has points to more securely hold the trunk in the position. The legs may be formed from sheet metal of heavy enough gage to form a strong and stable part. The sheet material may be bent into a U shape with the central part of the U forming the top of the leg. The edges of the sheet material then form the points 64 on the ends of the legs.

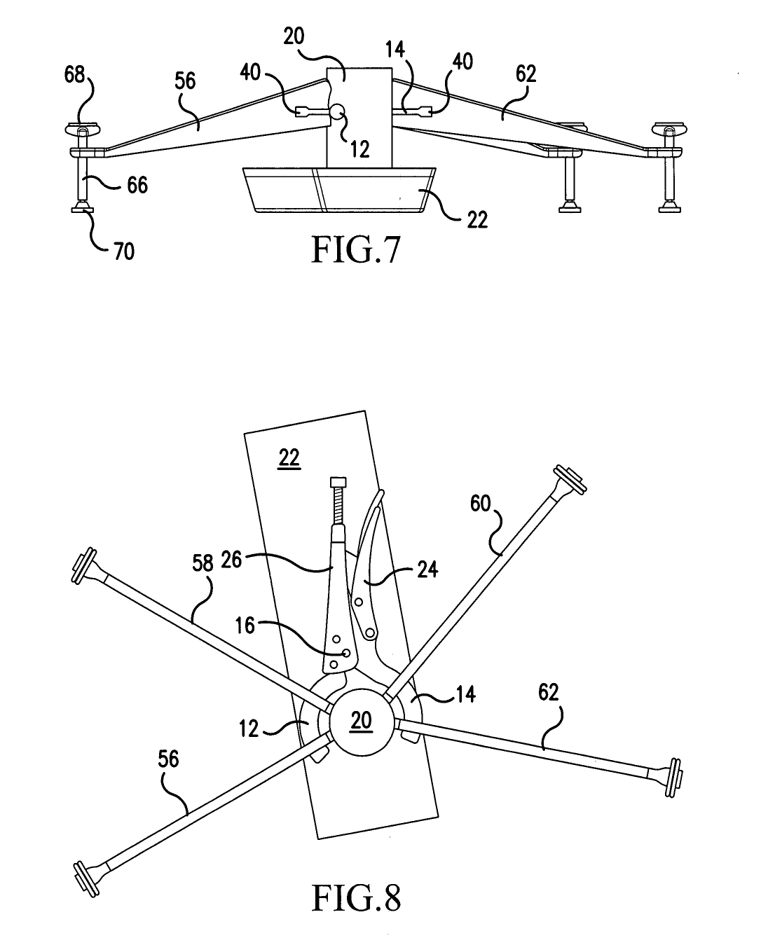

FIGS. 7 and 8 show another arrangement of the tree stand, where the tree trunk is considerably smaller then that shown in the previous figures. Also, is this figure the handles 24 and 26 have been moved to be above the pan 22. The extension of the legs inside the locking jaws is more clearly seen in this figure.

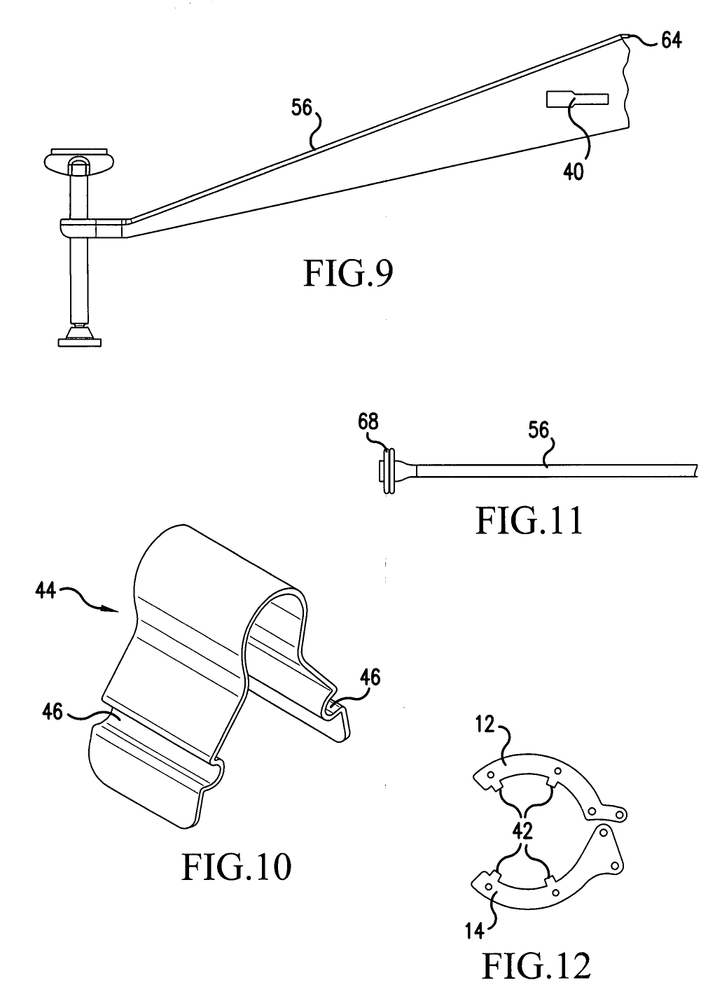

FIGS. 9 and 11 show views of a leg 56, including the pointed area 64 and the hole 40 for receiving the arms. The feet arrangement including shaft 66, wing nut 68 and pads 70 is also shown.

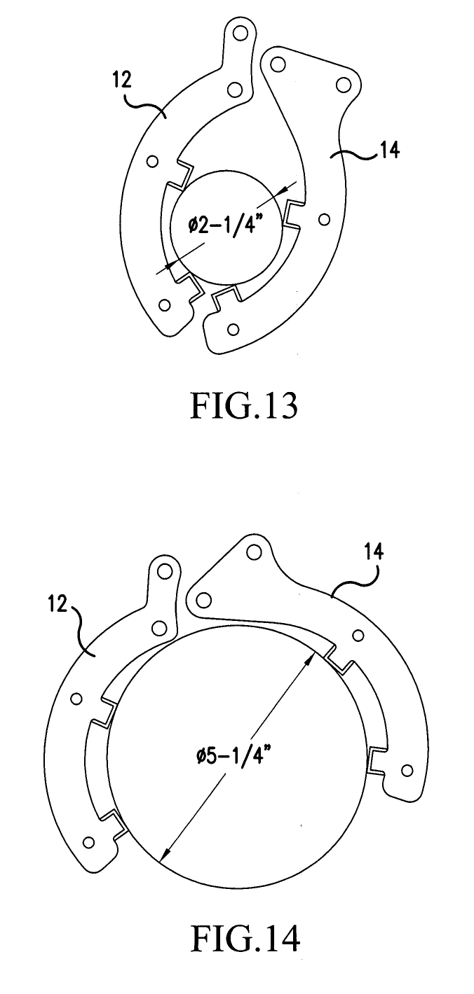

FIG. 12 shows the top view of the locking jaws 12 and 14 in their open position. FIGS. 13 and 14 show the locking jaws in a closed position on different diameter trunks. Lugs 42 extend inside the legs against the end 64 of the legs, so that when the arms are closed, the ends of the legs are supported by lugs.

FIG. 10 shows a locking clip 44 for use in hole 40 in each leg. After the legs are arranged over the locking arms, the locking clips may be inserted into the slot to hold the leg firmly in position. The depressions 46 on each side latch onto the top and bottom edge of the hole 40.

While the legs of this device have been shown as including a slot for receiving the arms, other arrangements for attaching the legs to the arms are possible. For example, the arms can be made thicker in the vertical direction with a vertical slot for receiving each of the legs. It would also be possible for the hole 40 to extend all the way to the front of the leg with a different arrangement for holding the arms and legs together.

When it is desired to remove the tree from the stand, the handles are disengaged so as to release the arms and legs from the trunk which is then lifted out of the pan and removed. The locking clips can then be removed freeing the legs from the arms. The legs can then be placed within the pan with the appropriate adjustments to the threading shaft 66, if necessary. The arm and handle arrangement can also be placed in the pan which is deep enough to receive the four legs and the arm arrangement together. If desired, a cover can be used which snaps over the top of the pan so that the package is complete for storage.

Although the present application has described the device as being used to hold a tree trunk, in fact this device may be used for other purposes, such as holding an advertising display, banner, flag, sign post or any other device which includes a circular shaft which be held vertically. When used for these purposes, the pan is not needed for watering, but still forms part of the device as the storage container.

There are numerous additional modifications and variations of the present inventions are possible in light of the above teachings. It is therefore to be understood that within the scope of the appended claims that the invention may be practiced otherwise as in specifically described herein.

What is claimed is:

1. A stand for supporting a cut tree trunk in a vertical position, comprising:
first and second locking arms, pivoting connected at one end;
a locking clamp including a fixed locking handle and a pivoted handle connected to said first locking arm and said second locking arm, respectively, for adjustably locking said locking jaws in position around a tree trunk;
a plurality of legs, each having a slot for receiving one of said locking arms and extending radially from said tree trunk;
inner ends of said legs contacting said tree trunk and being forced into position by said locking arms when said handles are clamped together.

2. The stand according to claim 1, further comprising a pan for receiving a bottom end of said trunk and placed between said legs for watering said tree trunk.

3. The stand according to claim 1, further comprising a plurality of feet, with one foot on an outer end of each leg for adjusting the height of the corresponding leg.

4. The stand according to claim 1, further comprising locking clips for holding said legs firmly against said arms.

5. The stand according to claim 1, herein said legs are removable from said arms for storage.

6. The stand according to claim 5, further comprising a pan for watering said tree trunk and for storing said legs and arms when not in use.

7. A kit for forming a stand for supporting a cut tree trunk in vertical position, comprising:
four legs, each leg having a slot formed therein;
a pair of locking arms pivotally connected and joined to a fixed locking handle and a pivotal handle so as to form a locking arrangement for the jaws;
said slots having a shape for receiving said arms so that said legs are clamped into engagement with said tree trunk.

8. A kit according to claim 7, further comprising a pan for receiving the tree trunk and for holding water, said pan having dimensions for receiving said legs and said jaws for storage when not in use.

9. The kit according to claim 7, further comprising a plurality of feet mounted in outer ends of said legs for adjusting the height thereof.

10. The kit according to claim 7, further comprising cover for said pan which engages said pan for storage.

11. The kit according to claim 7, further comprising locking pins for hold said arms in said slots.
